(19) United States
(12) Patent Application Publication
(10) Pub. No.: US 2022/0040927 A1
(43) Pub. Date: Feb. 10, 2022

(54) BUILD MATERIAL LAYER CONTROL

(71) Applicant: HEWLETT-PACKARD DEVELOPMENT COMPANY, L.P., Spring, TX (US)

(72) Inventors: Pol FORNOS MARTINEZ, Sant Cugat del Valles (ES); Ismael FERNANDEZ AYMERICH, Sant Cugat del Valles (ES); Cristina DOMINGUEZ MANCHADO, Sant Cugat del Valles (ES)

(73) Assignee: HEWLETT-PACKARD DEVELOPMENT COMPANY, L.P., Spring, TX (US)

(21) Appl. No.: 17/278,931

(22) PCT Filed: Apr. 23, 2019
(86) PCT No.: PCT/US2019/028694

§ 371 Date: Mar. 23, 2021

(51) Int. Cl. B29C 64/393; B33Y 10/00; B33Y 30/00; B33Y 50/02; B28B 1/00; B28B 17/00; B29C 64/165; B22F 10/85

(52) U.S. Cl. CPC B29C 64/393; B33Y 10/00; B33Y 30/00; B22F 10/85; B28B 1/001; B28B 17/0081; B29C 64/165; B33Y 50/02

(57) ABSTRACT

Example implementations relate to controlling the application of layers of build material in 3D printing. One example implementation determines a temperature at a predetermined location of a layer of build material following fusing according to an object model, where the predetermined location is dependent on the object model. The application of a new layer of build material is controlled dependent on the determined temperature.

### BACKGROUND

Three-dimensional objects may be produced by additive manufacturing processes which generate the object layer by layer using a three-dimensional (3D) printer. Example 3D printers may use build material fusion technologies in which fusion (sintering or melting) between some build material particles or fibers of plastic, metal, ceramic or other powders or fibers is performed one layer at a time. The unfused particles may be removed or reused, leaving the solid printed object. Temperature gradients and other printing artefacts can lead to inhomogeneous shrinkage of the fused particles which can cause shrinkage, distortion, warping and other distortions of the printed object.

### BRIEF DESCRIPTION OF THE DRAWINGS

Various features of the present disclosure will be apparent from the detailed description which follows, taken in conjunction with the accompanying drawings, which together illustrate features of the present disclosure, and wherein:

FIG. 1 illustrates an example controller for a three-dimensional printer according to an example;

FIG. 2 illustrates an example three-dimensional printer;

FIG. 3 illustrates a plan view of a layer of build material arranged into zones according to an example;

FIG. 4 is a flowchart of an example method of controlling the application of layers of build material according to an example;

FIG. 5 is a graph showing layer temperature at different operational stages of a 3D printer according to an example; and

FIG. 6 is a graph showing temperatures for different locations within a layer during operation of a 3D printer according to an example.

### DETAILED DESCRIPTION

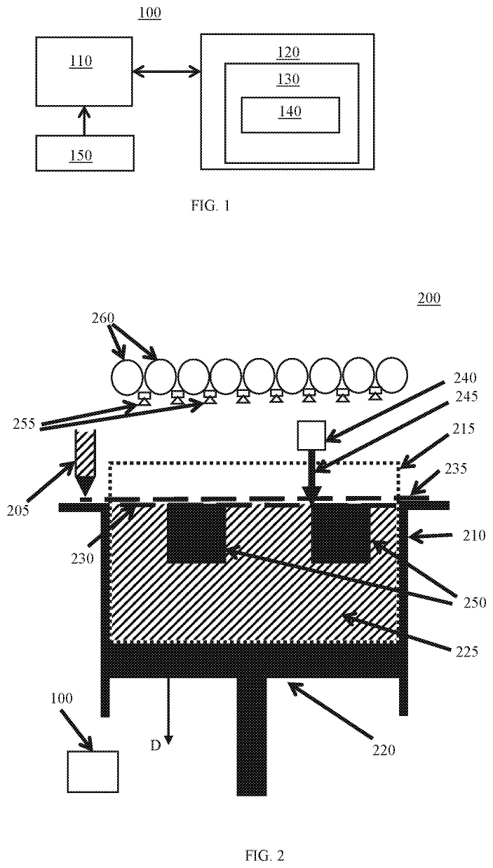

FIG. 1 illustrates an example controller 100 for a 3D printer which comprises a processor 110 couple to a memory 120 which includes a non-transitory computer-readable storage medium 130 such as a USB-drive or hard-disk drive for example. The processor receives an object model 150 describing an object to be printed by the 3D printer. Computer readable instructions 140 enable the processor to control the 3D printer to print a solid object using the object model by fusing parts in layers of build material and controlling the application of new layers depending on the temperature of the previous layers.

In some examples of three-dimensional (3D) printing, 3D objects are formed using thermal, piezo other printhead inkjet arrays. A layer of build material (eg a powder or fibers of plastic, ceramic or metal) is exposed to radiation, such that the build material is fused and hardened to become a layer of a 3D object. In some examples, a coalescent or fusing agent is selectively deposited (or “printed”) in contact with a selected region of the build material. The fusing agent is capable of penetrating into the layer of build material and spreading onto the exterior surface of the build material. The fusing agent is capable of absorbing radiation (e.g., thermal radiation, broadly referred herein as heat), which in turn melts or sinters the build material that is in contact with the fusing agent. This causes the build material to fuse or bind to form a layer of the 3D object. Repeating this process with numerous layers of build material causes the layers to be joined together, resulting in the formation of the 3D object.

In some 3D printing systems, a support member (e.g., also known as a powder bed) and any layers of build material are heated (broadly heating) to a certain target temperature range less than the temperature used for fusing. This temperature range is maintained throughout the 3D printing process and reduces the time for the fusing process and in addition some uniformity of temperature of the build material during the 3D printing process improves the quality of the finished objects. This heating can be provided using overhead lamps or short-wave infrared (IR) emitters deployed within the 3D object printing system to perform this pre-heating process.

In some non-limiting examples, the build material may be a powder-based build material, which may include both dry and wet powder based material, particulate materials and granular materials. In some examples, the build material may include a mixture of air and solid polymer particles, for example at a ratio of about 40% air and about 60% solid polymer particles. One suitable material may be Nylon 12, which is available for example from Sigma-Aldrich Co. LLC.

FIG. 2 illustrates one example of a 3D printer system. The 3D printer 200 is used to print a number of objects 250, and comprises a build chamber having build chamber walls 210 and a support member or build platform 220. The build platform 220 supports a plurality of layers of build material 225, and is movable during generation of the 3D object to accommodate each new layer of build material. The movement of the build platform 220 during layer by layer building of the 3D object is shown by arrow D. The build chamber has a build or printing volume 215 which is defined by the build chamber walls and the build platform when in its lowest position. In this example, the build volume 215 will therefore be at or below the top of the build chamber walls 210 when the last layer of build material has been added. For the purposes of the following explanation, a current or most recent layer 230 is shown at the highest level of the layers of build material 225, and a new or next layer 235 is indicated immediately above the current layer.

A build material distributor 205 is arranged to spread a layer of build material, such as a plastic or metal powder, at the top of the build chamber walls 210, along the line 235. A printhead (not shown) with nozzles is arranged to selectively direct or print a fusing agent to the top or new layer of build material. The fusing agent is a material that, when a suitable amount of energy is applied to a combination of build material and fusing agent, causes the build material to melt, sinter, fuse or otherwise coalesce and solidify. Example fusing agents include carbon black and liquids containing near infrared absorbent. The fusing agent may increase heating of the build material by acting as an energy absorbing agent that can cause the build material on which it has been deposited to absorb more energy (e.g. from a radiation source) than build material on which no agent has been deposited.

Preheating of the build material may be arranged to bring and maintain the temperature of the build material to close to the melting or fusing temperature of the build material. Application of the fusing agent to the build material layer may cause, during a subsequent application of energy to irradiate the build material, localized heating of the region of build material to a temperature above melting or fusing temperature. This can cause the region of build material to melt, sinter, coalesce or fuse, and then solidify after cooling. In this manner, solid parts of the object may be constructed. Preheating may be implemented using overheat heating lamps 260, however other arrangements are possible including moveable heating sources such as one or more infrared transmitters.

In certain examples, another printhead (not shown) may be used to apply a detailing agent to the new layer of build material. The detailing agent may act to modify the effect of the fusing agent and/or directly act to cool build material. This can result in more accurate definition of the solid parts of the object.

In the example a fusing energy source 240 is arranged to apply sufficient heat energy 245 to the layer of build material to cause local fusing. The heating apparatus 245 may comprise a high power movable infrared source providing an infrared beam 245 which moves across the layer of build material causing the parts of the layer having the fusing agent to fuse and form the solid parts of the object. The remaining parts of the layer of build material are left unfused. In an alternative arrangement, a series of infrared sources may be statically located adjacent the top layer of build material and operated to cause the same fusing process. The 3D printer 200 also comprises a controller 100 which operates the various described parts.

The 3D printer 200 also comprises temperature sensors 255 which measure the temperature of the current layer of build material 230. Following fusing of this layer, areas of build material corresponding parts of the object will have been exposed to heat energy to fuse the build material whereas other areas of the build material will not have been heated and fused. This means that parts of the current layer 230 will have a higher temperature than other parts immediately following fusing. Further the level of cooling following fusing may be affected by the location within the layer and different interactions with subsystems of the 3D printer. The inventors have identified that applying a new layer 235 onto the current layer 230 when there are significant temperature differences in the current layer 230 can contribute to dimensional variability and distortion of the printed object compared with the object model.

The temperature sensors 255 may comprise one or more thermal or thermographic cameras which measure infrared radiation to determine temperatures at different locations within their field of view. These cameras may be arranged to have a number of pixels corresponding to different locations of the current layer 230 and where a temperature is determined for each pixel or location. Other types of temperature sensors may alternatively be used in other examples.

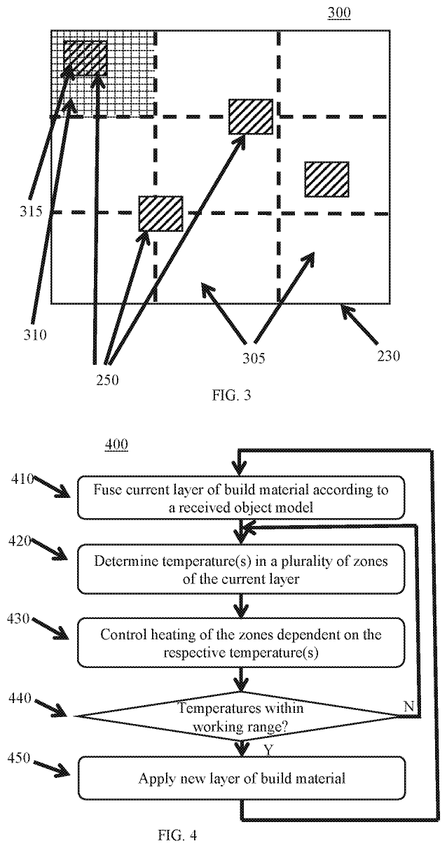

Referring also to FIG. 3, the temperature sensor or sensors 255 determine temperatures for a plurality of zones 305 of the current layer of build material 230. Differences in the determined temperature in each zone 305 can be used to control the 3D printing process, including delaying the application of a new layer of build material 235 until the determined temperatures of the current layer 230 reach a predetermined level of uniformity across the different zones.

Each zone 305 may be heated by one or more respective heating source such as infrared lamps 260 so that its heating can be controlled independently of other zones.

In the example of FIG. 3, nine zones 305 are defined for the current layer of build material 230, however any number of zones may be used. A number of pixels 310 of one or more temperature sensors may be associated with locations within each zone. For simplicity one pixel matrix is shown but it will be understood that the other zones have similar pixels matrices associated with a temperature sensor for determining temperatures at different locations within the zone. It will also be appreciated that the number of pixels shown is merely indicative and a greater or lesser number of pixels for each zone may be employed in other examples.

A number of areas of fused build material are associated with object parts 250. Following fusing of the object parts 250, the temperature in the corresponding pixels will be elevated compared with the temperatures determined for other locations. Whilst the locations associated with the object parts 250 will cool afterwards by convection, the rate of cooling will depend on many factors and is not consistent across the parts. This may result in significant differences in temperature across the zones 305 which, were a new layer of build material 235 to be added, can result in dimensional variation or distortion of the parts 250. Allowing the determined temperatures to reach a certain level of uniformity and/or to reach a desired predetermined or working range of temperatures mitigates this effect.

The locations of pixels corresponding to object parts in which the build material has been fused are known from an object model used to generate the object parts. These pixels are referred to herein as object part pixels or “black” pixels. The locations of pixels corresponding to unfused build material are also determined from the object model and are referred to herein as unfused build material pixels or “white” pixels.

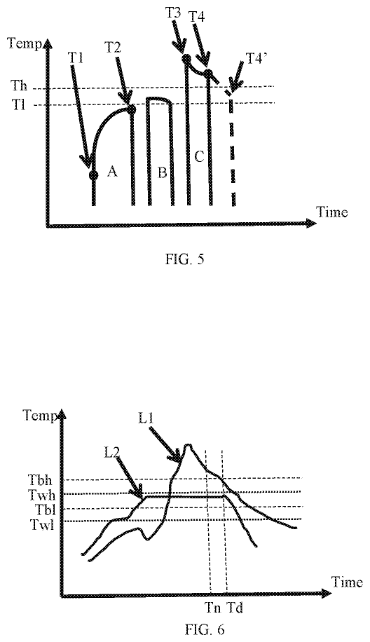

FIG. 5 illustrates the temperatures associated with a single location (black pixel) in a layer of build material associated with an object part and during different stages in the 3D printing process. In a first stage A, the build material distributor 205 spreads the layer of build material 230 onto the block of already processed build material 225. The build material is at an initial temperature T1 following spreading and is then heated by the heating lamps 260 to a temperature T2 approaching but below a fusing temperature. In a second stage B, fusing agent is selectively applied according to an object model. This may result in a small fall in temperature as shown.

In a third stage, fusing energy is applied to fuse the build material resulting in a high temperature T3. The build material is allowed to cool to a temperature T4 immediately prior to spreading of a new layer of build material 235. If this pre-spreading or “bury” temperature T4 is too high (or too low) this can result in distortions to the printed object. In previously known 3D printer systems, the timing of the spreading was predetermined and controlled in an open loop manner. However as noted this can result in distortion of the part and in the example this spreading timing or application of a new layer of build material is adjusted depending on the temperature T4. In this example, the bury or pre-spreading temperature T4′ is allowed to cool to within a working range (Th-Tl) before the next spreading stage is started.

FIG. 6 shows the temperature over time of two locations in a layer of build material 230. The first location L1 corresponds to the object part or black pixel location associated with FIG. 5. The temperature increases as the build material is heated by the heating lamps 260, cools slightly with application of the fusing agent, and increases significantly with application of fusing energy. Thereafter the temperature cools to within the working range (Tbh-Tbl) by allowing convection cooling without applying any further heating using the heating lamps 260. Whilst in previously known 3D printer systems, the next layer of build material would have been applied at time Tn irrespective of the temperature of the current layer, in the example this process is delayed until a later time Td when the determined temperature at location L1 is within the working range Th-Tl.

The second location L2 corresponds to an unfused build material or white pixel location where the layer of build material is not fused and is not associated with an object part. This location L2 may be in a different zone 305 of the layer of build material and is heated by the heating lamps 260 to, and maintained within, a range of temperatures (Twh-Twl) by appropriate control of the heating lamp(s)s within the zone, until the delayed time Td for applying the next layer. The range of temperatures (Twh-Twl) for locations of unfused build material (white pixels) may be the same as or lower than the working range (Tbh-Tbl) for locations of fused object parts (black pixels). A lower temperature range for unfused build material locations (white pixels) reduces the risk of unwanted fusing of build material not intended to form object parts. In an example in zones having both fused object parts (black pixels) and unfused build material (white pixels), the heating lamps are controlled primarily to control the determined temperature of the black pixel locations to fall within the working range (Tbh-Tbl) which may be achieved by switching off or reducing the power of the heating lamps in that zone to allow convection cooling, even if this may mean that some locations of unfused build material (white pixels) fall below their predetermined range of temperatures (Twh-Twl) due to the convection cooling.

In an example, locations or pixels corresponding to object parts 250 (black pixels) may be used to determine the timing of the application of the next layer of build material. The temperatures of these parts will be the most elevated, due to fusing, compared with other unfused building material locations or white pixels of the current layer 230. Delaying spreading of the next layer allows cooling of these object parts (black pixels) to within the working range temperature (Tbh-Tbl) whilst maintaining unfused build material in other areas of the layer within the same or a lower temperature range (Twh-Twl) to allow a suitable level of uniformity of temperature to be achieved across the current layer of build material 230 before applying the next layer 235.

In an example, a predetermined number of object part (black) pixels 315 being within a working range (Tbh-Tbl) may be used to trigger application of the next layer of build material 235. For example, if 50 object part (black) pixels 315 have determined temperatures within the working range (Tbh-Tbl), then the application of the next layer 235 of build material is triggered. This may be further delayed if the determined temperature of a number of other object part (black) pixels 315 exceed a threshold. A timeout may be used to ensure good behavior of the system, so that after a predetermined period following application of the current layer, completion of fusing or some other suitable time, the new layer is spread even if the above trigger conditions have not been met. Alternatively, if the predetermined period is reached and the trigger condition is not achieved, this may indicate a high likelihood of distortion of object parts and the printing process may be terminated.

In an example, the determined temperatures of locations of unfused build material (white pixels) may be used to control the timing of application of the next layer of build material. In this example if the determined temperatures of one or a number of unfused build material locations (white pixels) exceed a threshold (Twh), application of the new layer of build material 235 may be triggered. A higher temperature of unfused build material may risk some fusing and therefore distortion of the finished object and application of the new layer of build material will cool the temperature at this location reducing this risk. This is because the new layer of build material will be at a lower temperature initially than the current layer following fusing.

Thus, the timing of the application of a new layer of build material can be controlled according to the determined temperatures at locations of both fused object parts (black pixels) and unfused build material (white pixels). Various control strategies can be employed including weighting the impact of the black and white pixel temperatures. For example, application of the new layer of build material may be triggered if 50 black pixels fall within the working range (Tbh-Tbl) or if 20 black pixels fall within the working range (Tbh-Tbl) and 20 white pixels have fallen below a threshold temperature (Twl).

A method of printing 3D objects according to an example is shown in FIG. 4. This may be implemented by the 3D printer of FIG. 2 controlled by the controller of FIG. 1. The method 400 illustrates part of a process for printing a 3D object according to an object model. The object model may be provided in the form of object model data such as an STL file comprising tessellation of the object. Object models for a number of objects 250 may be received together with their locations within the printing volume 215.

The printer at 410, having applied fusing agent and in some examples detailing agent to a current layer of build material 230, applies fusing energy to the current layer. The current layer is selectively fused according to the object model data by the interaction of the fusing energy and the fusing (and detailing) agent in order to generate object parts 250.

The printer is then controlled to determine temperature at a plurality of locations of the current layer at 420. A range of options for determining zone temperature is possible, including a single temperature associated with each zone, a plurality of temperatures (temperature sensor pixels) corresponding to different locations within each zone, or a plurality of temperatures corresponding to different locations of object parts (black pixels) and/or a plurality of temperatures corresponding to different locations of unfused build material (white pixels).

The printer is then controlled to control heating of the zone dependent on the determined temperatures at 430. The heating control may be implemented using the heating lamps 260 to independently control the temperatures of the current layer of build material 230 within each zone. Zones containing object parts 250 may be allowed to cool by switching off or reducing power to their heating lamps. Zones of build material without object parts may be heated to and/or have their temperatures maintained within a predetermined temperature range (Twh-Twl). Thus, determined temperatures may be adjusted in individual zones by increasing, maintaining or cooling.

The printer is then controlled to determine whether to trigger the application or spreading of a new layer at 440. As explained above, this can be achieved by determining that a predetermined number (eg 50) of object part (black) pixels 315 are within a predetermined temperature range (Tbh-Tbl). This may be within the same zone (for example if there is one object part in the layer of build material) or in different zones. The trigger may be dependent on a predetermined number of black pixels 310 corresponding to object part locations and/or a predetermined number of white pixels corresponding to unfused build material locations. In an example, control of the heat lamps is applied in zones containing object parts 250 and not in other zones.

If there are insufficient temperatures within the working range (440N), then the method continues to determine temperatures at 420. If there are sufficient temperatures within the working range (440Y), then this triggers the application of a new layer of build material at 450. In an example the build material distributor 205 is controlled to distribute the additional build material on top of the current layer 230 to form a new layer of build material 235.

The example can provide improved thermal homogeneity of the build material, reduced dimensional variability and improved characteristics of the printed object including look and feel, more uniform accuracy and more uniform mechanical properties. Because of this process repeatability and process capability index (CPK) is improved leading to lower cost parts. The example can also reduce the likelihood of outlier parts of the layer regularly generating sub-standard objects.

The preceding description has been presented to illustrate and describe examples of the principles described. This description is not intended to be exhaustive or to limit these principles to any precise form disclosed. Many modifications and variations are possible in light of the above teaching. It is to be understood that any feature described in relation to any one example may be used alone, or in combination with any features described, and may also be used in combination with any feature of any other examples, or any combination of any other examples.

What is claimed is:

1. A method comprising:
determining a temperature at a predetermined location of a layer of build material
following fusing according to an object model in a 3D printer, the predetermined location being dependent on the object model;
controlling the application of a new layer of build material dependent on the determined temperature.

2. The method of claim 1, comprising:
applying the new layer of build material in response to determining that the determined temperature at the predetermined location is within a predetermined range.

3. The method of claim 2, wherein the predetermined location corresponds to a fused object part.

4. The method of claim 2, wherein the predetermined location corresponds to unfused build material.

5. The method of claim 2, wherein temperatures at a plurality of locations are determined and applying the new layer is in response to determining that a predetermined number of the temperatures corresponding to locations of a fused object part are within a first predetermined range and/or determining that a predetermined number of the temperatures corresponding to locations of unfused build material are within a second predetermined range.

6. The method of claim 2, wherein a heat source is controlled in order to control the temperature at the predetermined location.

7. The method of claim 6, wherein the heat source is arranged to independently control heating applied to multiple zones of the layer of build material, and wherein the heating of at least one zone is controlled dependent on the determined temperature of a location of build material within that zone.

8. The method of claim 7, wherein a zone having a fused object part is allowed to cool in order to reduce a temperature at a predetermined location in the zone, and a zone without a fused object part has heating applied to increase or maintain a temperature in that zone.

9. A 3D printer comprising:
a build material distributor arranged to apply layers of build material onto a support;
a fusing energy source arranged to fuse the layer of build material according to an object model;
a temperature sensor arranged to determine a temperature at a predetermined location of the layer of build material following fusing, the predetermined location being dependent on the object model;
a processor arranged to control the build material distributor to apply a new layer of build material depending on the determined temperature.

10. The 3D printer of claim 9, wherein the processor is arranged to apply a new layer of build material in response to determining that the determined temperature at the predetermined location is within a predetermined range.

11. The 3D printer of claim 9, wherein the temperature sensor is arranged to determine temperatures at a plurality of locations and the processor is arranged to apply the new layer is in response to determining that a predetermined number of the temperatures corresponding to locations of a fused object part are within a first predetermined range and/or determining that a predetermined number of the temperatures corresponding to locations of unfused build material are within a second predetermined range

12. The 3D printer of claim 9, comprising a heat source controlled by the processor to control the temperature of the layer of building material at the predetermined location.

13. The 3D printer of claim 10, wherein the heat source comprises a plurality of heating lamps arranged to independently control heating applied to multiple zones of the layer of build material.

14. The 3D printer of claim 13, wherein the heating lamps are controlled to adjust the heating applied to at least one zone dependent on the predetermined temperature of a location of build material within that zone.

15. A non-transitory computer-readable medium storing instructions which, when executed by a processor, causes the processor to perform operations, the operations comprising:
determine a temperature at a predetermined location of a layer of build material following fusing according to an object model in a 3D printer, the predetermined location being dependent on the object model;
control the application of a new layer of build material depending on the determined temperature.
